(19) United States
(12) Patent Application Publication
(10) Pub. No.: US 2008/0251501 A1
(43) Pub. Date: Oct. 16, 2008

(54) System for Linking Welding Studs to Workpieces and Device for Positioning and Separating Welding Studs for Such a System

(76) Inventor: Heiko Schmidt, Lappersdorf (DE)

Correspondence Address: HOFFMAN WASSON & GITLER, P.C;CRYSTAL CENTER 2, SUITE 522, 2461 SOUTH CLARK STREET, ARLINGTON, VA, 22202-3843, US

(21) Appl. No.: 11/661,357

(22) PCT Filed: Aug. 22, 2005
(86) PCT No.: PCT/DE05/01469

§ 371 Date: May 27, 2008

(30) Foreign Application Priority Data
Sep. 2, 2004 (DE) 10 2004 042 969.3

(51) Int. Cl. B23K 11/04

(52) U.S. Cl. 219/107; 219/103

(57) ABSTRACT

The invention relates to a system for introducing studs (2) into work pieces by welding using a welding station which is supplied with the studs via a conveyor section (11).

### BACKGROUND OF THE INVENTION

The invention relates to a system and to a device for separating and positioning welding studs or bolts for use in such a system.

It is an object of the invention is to present a system with which the particularly reliable separation and accurate positioning of welding studs or bolts facilitates the particularly reliable and operationally safe joining of said welding studs to workpieces by means of welding.

### SUMMARY OF THE INVENTION

The device for separating and accurate feeding is part of the overall conveyor line by which the welding studs are fed to the welding station. The studs are fed from a supply unit by means of injection, preferably via a flexible outer element of the conveyor line that is preferably formed by a supply hose, and then are transported, preferably via a curved guide, in which the feed and injection movement is braked, to a loading position, at which then a holder for holding one welding stud at a time is formed in a specified orientation. The respective welding stud is moved from this holder to the welding station via a forward feed element and a rigid stud guide or a loading channel, during which the orientation defined by the guide is maintained. The movement stroke of the forward feed element is a multiple of the diameter of the stud head of the welding stud, so that during the welding process especially the functional elements provided at the loading position, but also the forward feed element retracted to the loading position or in the direction of the loading position, are at a sufficient distance from the welding station or the welding position located there, thus effectively preventing impairment to these elements by the welding process, in particular also due to electromagnetic fields that occur during welding.

### BRIEF DESCRIPTION OF THE DRAWINGS

The invention is described in more detail below based on an exemplary embodiment with reference to the drawings, in which:

FIG. 1 shows a simplified representation, partially in longitudinal section, of a device for separating and feeding welding studs or bolts to a welding station or position;

FIG. 2 shows a simplified schematic representation of the holder or loading bushing of the device in FIG. 1 provided at the injection or loading position;

FIG. 3 shows a simplified representation in cross section of the device in the vicinity of the loading bushing with the conveyor slider moved forward; and

FIG. 4 shows a cross section of the guide formed between the loading bushing and the welding position.

### DETAILED DESCRIPTION OF THE INVENTION

For the sake of clarity, the perpendicularly oriented spatial axes are designated X, Y and Z in the drawings. The stud axis of the stud held in the loading bushing is then oriented in the Y-axis.

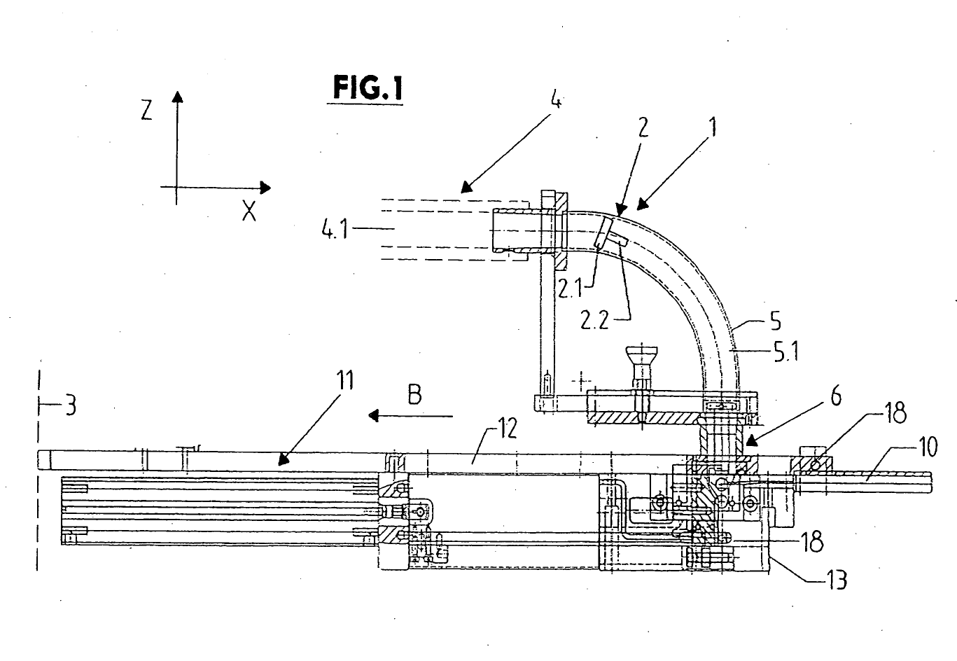

The device generally designated 1 in the drawings is used for the separation and feeding of welding studs 2 to a welding station 3, schematically indicated in FIG. 1, at which said studs 2 are electrically joined to a component by means of resistance welding.

The studs 2 are fed from a supply unit not depicted via a supply hose 4 by means of injection, i.e. with compressed air, namely with the free end of the stud shaft 4.2 distant from the stud head 4.1 in front, and are then transported via a guide channel 5.1 formed by a curved pipe section 5 to a loading position 6. At this position there is a loading bushing 7, which forms a funnel-shaped holder for one welding stud 2 or its stud shaft 2.2.

In the depicted embodiment, the loading bushing 7 is designed so that the stud 2 located at the loading position is held with its stud shaft 2.2 in an opening 8 of the loading bushing, which is formed by two swiveling segments 9 and during injection of the respective stud 2 by one end of a ram 10.

The head 2.1 of the respective stud 2 located in the loading position lies with its bottom side facing the stud shaft 2.2 on the top side of the segments 9 oriented in a common XY-plane.

After injection of a welding stud 2 into the loading position 6, said stud is then moved to the welding station 3 with a slider 10 via a rigid guide 11 adjoining the loading position 6. The guide 11 in the depicted embodiment is designed as a T-groove in a strip-shaped support strip 12, which is oriented longitudinally in the X-axis and in which the respective welding stud 2 is held suspended with its head 2.1.

The two segments 9 are fastened to a housing 14 of the device 1 by means of joints 13 against the effect of non-depicted spring means corresponding to the arrows A so that the segments can swivel on an axis parallel to the Z-axis from the closed position, in which recesses of the segments 9 form the opening 8, into an open position. The housing 14 is fastened on the bottom side of the support strip 12 facing away from the guide 5, which (support strip) extends from the loading position 6 to the welding station 3, as does the guide 11.

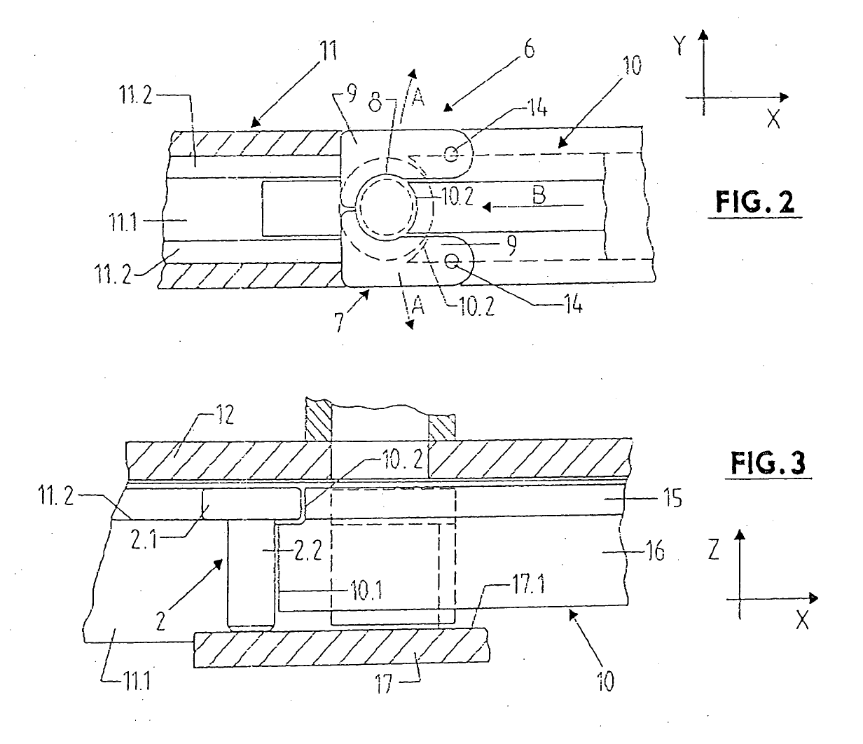

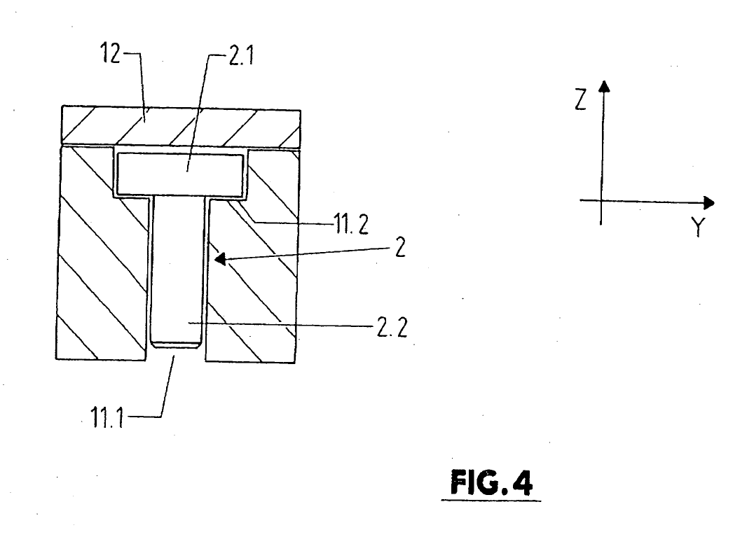

With an actuating element not depicted, the slider 10 can be moved in the direction of the X-axis along the guide 11 from its starting position depicted in FIG. 2 in which said slider with its slider surface 10.1 likewise partially limits the opening 8 and with its slider surface 10.2 bears against the head 2.1 of the welding stud 2 located in the loading position 6, to a position (working stroke B), in which the respective welding stud 2 is moved from the loading position 6 into the proximity of the welding station 3 or into a holder located there. The slider 10 has a T-shaped cross section with an upper slider section 15, on which also the surface 10.2 is formed, and a plate 16 adjoining to the slider section 15 that forms the surface 10.1 and moves with the motion of the slider from the starting position into the slot 11.1 of the guide.

In the depicted embodiment the guide 11 is designed so that the respective stud shaft 2.2 is held along its entire length in the guide 11.

During forward movement of the slider 10 from the starting position, the stud shaft 2.2 of the welding stud 2 moved with said slider causes the two segments 9 to be pressed to the side around their joint 14 against the effect of the pull-back springs, so that the stud 2 can move with its stud shaft 2.2 past the laterally displaced segments 9 into the guide 11. Due to the slider 10, the two segments 9 remain in their opened, laterally swiveled position until the slider 10 has returned to the starting position.

The joints 14, which are located with their axes in a common YZ-plane, are somewhat more distant from the welding station 3 than the axis of the opening 8 with segment 9 closed.

With the slider pushed forward from the starting position, it closes with its top side or with the top side of the slider section 15 the guide channel 5.1 toward the loading bushing 7, so that a further welding stud 2 can already be injected via the supply hose 4 and the guide 5 before the return of the slider 10 to its starting position and the stud then slides with its stud shaft 2.2 into the opening 8 after the return of the slider 10 to the starting position. In this process it is also possible to effect the injection of the welding stud 2 so that several adjacent welding studs 2 are provided in a row in the guide channel 5.1 of the guide 5, so that then the first welding stud 2 of said row slides into the loading bushing 7 or its opening 8 after the return of the slider into the starting position. The fact that a welding stud 2 is ready at the loading position 6 for reception into the loading bushing 7 before the return of the slider 10 to its starting position results in very short cycle times for the device 1, based on the time required for the injection of the welding studs 2.

As depicted in FIG. 3, the lower end of the opening 8 is closed by the surface 17.1 of a plate 17, so that each welding stud 2 that is received with its stud shaft 2.2 into the opening 8, bears with the lower free end of the stud shaft against the surface 17.1, and therefore the bottom side of the stud head 2.1 facing the stud shaft 2.2 is at a distance from the top of the segments 6 and is held with said bottom side at a level that is somewhat higher than the level of the slider surface 11.2 formed by the guide 11, on which surface the respective welding stud 2 finally slides with the bottom side of its head 2.1 during forward movement to the welding station 3. The surface 17.1 extends also in the forward feed direction B of the slider over such a length that the respective welding stud 2 that is moved forward to the welding station 3 first continues to slide with the free end of its stud head 2.2 on the surface 17, until the stud head 2.1 is fully received in the guide 11. This ensures the secure, trouble-free transfer of the respective welding stud 2 from the loading bushing 7 to the guide 11.

A sensor 18 for detecting the presence of a welding stud 2 is provided at the loading bushing 7. The drive for the forward motion of the slider 10 is released only if a welding stud 2 is detected in the loading bushing 7. At least one additional sensor 19 is provided for monitoring the position of the slider 10 in the pushed forward end position. The drive for the slider 10 is designed so that the forward motion of the slider 10 is not stopped until a welding stud 2 being moved forward bears with its head 2.1 against a stop at the welding station 3. This results in two different end positions for the slider 10, namely one end position if a welding stud 2 is present at the slider 10 or is being carried with the slider and one additional deviating end position if no welding stud 2 is present. From these different end positions, the forward feed of one stud 2 to the welding station 3 is monitored by the sensor 19 and controlled accordingly.

The special feature of the device 1 consists in the fact that for each working stroke of the slider 10, only one welding stud 2 is moved by the slider from the loading position 6 to the welding station 3 and that the guide 11 in the direction of the X-axis nevertheless has a length that is a multiple of the diameter of the stud head 2.1. This design effectively prevents disruptions, especially of the loading bushing, of the drive for the slider 10 and of the sensors 18 and 19 due to magnetic fields that occur during welding. The design also prevents welding studs 2 from being welded accidentally within the device 1.

The guide 11 is manufactured from a non-magnetizable or difficult-to-magnetize steel or from a non-ferromagnetic and electrically non-conductive material.

### REFERENCE LIST

1 device for feeding and separating welding studs
2 welding stud or bolt
2.1 stud head or bolt head
2.2 stud shaft or bolt shaft
3 welding station
4 supply hose
5 guide
5.1 guide channel
6 loading position
7 loading bushing
8 opening of the loading bushing
9 segment
10 slider
10.1, 10.2 slider or driver surface
11 guide
11.1 slot
11.2 inner guide surface for stud head
12 support
13 housing
14 joint
15, 16 slider section of the slider with T-shaped cross section
17 deflector plate
17.1 guide surface
18, 19 sensor
A direction of motion of segments 9 during opening
B forward feed direction of slider 10
X, Y, Z spatial axis

What is claimed is:

1. A system for joining studs or bolts to workpieces by means of welding with a welding station or position, to which the studs are fed via a conveyor line, wherein a device for the separation and accurate positioning of the studs is provided in the conveyor line before the welding station.

2. The system according to claim 1, wherein the device for the separation and accurate positioning comprises a stiff or rigid stud guide or bolt guide extending from a loading position to the welding station, in which the studs are moved via a forward feed element from the loading position to the welding station, and the corresponding movement stroke of the forward feed element is significantly greater than the diameter of a head of one stud.

3. The system according to claim 2, the wherein a forward stroke of the forward feed element is greater than twice the head diameter of the welding studs.

4. The system according to claim 2, wherein the forward feed element is a slider.

5. The system according to claim 2, wherein a loading bushing at least for holding the shaft of the respective welding stud is provided at the loading position for alignment of the welding studs.

6. The system according to claim 5, wherein the loading bushing or its space serving to hold a welding stud or a stud shaft is formed by at least two spring-mounted catches or segments that give way to the respective welding stud and the forward feed element during the forward motion.

7. The system according to claim 2, further comprising means for closing the loading position when the forward feed element is actuated.

8. The system according to claim 7, wherein the means for closing are formed by the forward feed element or a section of said element.

9. The system according to claim 2, wherein a bearing and guide surface for the leading stud end that is distant from the stud head during feeding is provided at the loading position, and that the distance of this guide surface from a plane in which the slider surface for one bottom side of the stud head of the stud guide is located, is smaller than the axial length of the stud shaft protruding over the bottom side of the stud head.

10. The system according to claim 2, wherein the stud guide is formed by a T-shaped guide channel or a T-groove.

11. The system according to claim 2, wherein the stud guide is formed by a C-profile.

12. The system according to claim 2, wherein at least one sensor that responds to the presence of a stud is provided at least at the loading position.

13. The system according to claim 2, wherein at least one sensor that monitors the respective end position of the forward feed element.

14. A device for the separation and accurate positioning of welding studs in a system for joining said studs to workpieces by means of welding with a welding station wherein the device comprises a rigid stud guide extending from a loading position to the welding station, in which the studs are moved via a forward feed element from the loading position to the welding station, and the corresponding movement stroke of the forward feed element is significantly greater than the diameter of the head of one stud.

15. The device according to claim 14, wherein the forward stroke of the forward feed element is greater than twice the head diameter of the welding studs.

16. The device according to claim 14 wherein the forward feed element is a slider.

17. The device according to claim 14, further comprising a loading bushing at least for holding the shaft of the respective welding stud is provided at the loading position for alignment of the welding studs.

18. The device according to claim 17, wherein the loading bushing or its space serving to hold a welding stud or a stud shaft is formed by at least two spring-mounted catches or segments that give way to the respective welding stud and the forward feed element during the forward motion.

19. The device according to claim 14, further comprising means for closing the loading position when the forward feed element is actuated.

20. The device according to claim 19, wherein the means for closing are formed by the forward feed element or a section of said element.

21. The device according to claim 14, further comprising a bearing and guide surface for the leading stud end that is distant from the stud head during feeding is provided at the loading position, and that the distance of this guide surface from a plane in which the slider surface for one bottom side of the stud head of the stud guide is located, is smaller than the axial length of the stud shaft protruding over the bottom side of the stud head.

22. The device according to claim 21, wherein the stud guide is formed by a T-shaped guide channel or a T-groove.

23. The device according to claim 21, wherein the stud guide is formed by a C-profile.

24. The device according to claim 21, further comprising at least one sensor that responds to the presence of a stud is provided at least at the loading position.

25. The device according to claim 14, wherein at least one sensor that monitors the respective end position of the forward feed element.
